(19) United States
(12) Patent Application Publication
(10) Pub. No.: US 2010/0066071 A1
(43) Pub. Date: Mar. 18, 2010

(54) BLUEBOOK

(76) Inventor: Emmanouil Kelaidis, london (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/305,990

(22) PCT Filed: Jun. 22, 2007
(86) PCT No.: PCT/GB2007/002341

§ 371 Date: Jul. 6, 2009

(30) Foreign Application Priority Data
Jun. 22, 2006 (GB) 061434.1

(51) Int. Cl. G09B 5/06; B05D 5/12; B41M 1/12; B42D 3/12; B42C 1/00

(52) U.S. Cl. 281/15.1; 427/58; 101/129; 434/309; 412/1

(57) ABSTRACT

A method of making a book including interconnected electrical components, the method comprising the step of applying a conductive ink to a sheet of material to define a conductive track on the sheet from a point on the surface of the sheet to edge of the sheet such that the conductive track extends beyond the edge of the sheet generally in the plain of the sheet to form an electrical connection point.

### FIELD OF THE INVENTION

This invention relates to a method of making a book including interconnected electrical components.

### BACKGROUND TO THE INVENTION

It is apparent that books have certain inherent qualities that still make them today an irreplaceable medium. Books have survived unchanged for centuries making them one of the most successful, familiar and best-selling products worldwide. However, new digital media for carrying information such as portable devices, touch-screens etc. offers new possibilities to the user, especially in terms of interactivity with the content.

Can these two worlds, the digital and the analogue, co-exist in a product that would offer the benefits of both of these two worlds?

U.S. Pat. No. 4,990,092 (Cummings) discloses a “talking book” including a number of pages connected between two covers by a binder. The various pages have spots which overlie and are vertically aligned with switches that are formed in the back cover, such that pressure applied to a spot on any of the pages is transmitted through the remaining pages to the corresponding switch. Actuation of such switches causes activation of a voice chip located within the back cover. The voice chip sends signals to a speaker that also is located in the back cover, thereby producing audible sounds that correspond to the particular spot which was pressed.

U.S. Pat. No. 4,809,246 (Jeng) discloses a talking book including front and back covers in a loose leaf binder connected to the pages. Batteries, an electronic circuit board, a speaker, and switches are located in the back cover. Indicia on the pages indicate to the user which of the switches to manually depress to activate corresponding sounds chips to cause the speaker to produce sounds corresponding to such indicia.

Other similar inventions include U.S. Pat. No. 5,167,508 (Taggart), US2005/0100874 (Arkush) and US2003/0108855 (Kuen).

These electronic books, some of which have been extensively marketed, have been quite expensive and difficult to manufacture, resulting in higher manufacturing costs. Some of the prior art electronic books require the reader to make a correlation between a particular indicia on a page and a switch that must be actuated elsewhere. Furthermore, the number of hyperlinks that can be provided in a particular sized book is quite small for some of these electronic books. Some of these inventions require an extra (plastic) element as an indispensable companion to the book which houses the electronics, speaker, batteries, buttons etc. or incorporate it into the book's design as an integral element making the book a quite bulky and unfamiliar artefact. The inherent advantages of a book—its portability, durability, flexibility and ease of use—lose their importance, making similar digital devices (PDAs/e-Books) probably more suitable for the purpose.

It would be desirable to provide an electronic book which is of higher reliability, lower cost, lighter weight, and capable of having many more hyperlinks in a book of given size than any of the prior art electronic books, and which also does not require the reader to make a correlation between a particular indicia on a page and a switch located elsewhere.

Most importantly, such a book should evoke the same tactile, visual and emotional experiences the users would have, if they held a regular analogue book in their hands.

### SUMMARY OF THE INVENTION

This invention provides a method of making a book including interconnected electrical components, the method comprising the step of applying a conductive ink to a sheet of material to define a conductive track on the sheet from a point on the surface of the sheet to the edge of the sheet such that the conductive track extends beyond the edge of the sheet generally in the plain of the sheet to form an electrical connection point.

It may be that the conductive track extends beyond the edge of the sheet by virtue of the surface tension of the wet conductive ink.

It may be that the method further comprises the step of forming a stack comprising a plurality of said sheets. If this is the case, it may be that the electrical connection points of successive sheets in the stack are aligned in a direction perpendicular to the plane of the sheet, such that the electrical connection points form an electrical contact from sheet to sheet. It may further be that the aligned electrical connection points provide a conductive pathway from a first sheet of the stack having a conductive track defined thereon to another sheet of the stack, preferably the lowest sheet of the stack.

It may be that the stack includes sheets with electrical connection points having a conductive track of negligible length such that the electrical connection points operate only to connect electrically the neighbouring sheets in the stack.

It may be that the conductive ink is applied to the sheet by printing, preferably screen printing.

It may be that the method further comprises the step of binding the stack of sheets into a book.

This invention also provides a book made according to one of these methods.

### BRIEF DESCRIPTION OF THE DRAWINGS

An embodiment of the invention will now be described, by way of example only, and with reference to the accompanying drawings, in which:

FIG. 1 is an illustration of a test sheet used in evaluating conducting inks;

FIGS. 2 to 6 show details from the test sheet with values obtained during testing marked on them;

FIGS. 7 to 12 show a variety of possible switch designs according to an embodiment of the invention;

FIGS. 13 and 14 are illustrations of sample pages provided with switches according to an embodiment of the invention;

FIG. 15 is a block diagram illustrating the interface structure of an embodiment of the invention;

FIG. 16 is a circuit diagram illustrating a switch according to an embodiment of the invention;

FIG. 17 is a graph showing the behaviour of voltage over time in an ideal switch;

FIG. 18 is the circuit diagram of a prototype circuit board built to evaluate the actual behaviour of switches according to the invention;

FIG. 19 is a graph showing the behaviour of voltage over time in a switch according to an embodiment of the invention;

FIG. 20 is a circuit diagram of a main circuit board according to an embodiment of the invention;

FIG. 21 is a diagram illustrating an embodiment of the invention using Japanese book binding;

FIG. 22 is a diagram illustrating an embodiment of the invention using section-binding;

FIG. 23 is a diagram illustrating another embodiment of the invention using section binding;

FIG. 24 is a diagram illustrating a route for a conducting thread through a book according to one embodiment of the invention;

FIG. 25 is a diagram illustrating how the thread could be threaded through the book in this and similar embodiments;

FIG. 26 is an illustration of a fore-edge painting apparatus in use;

FIG. 27 is an exploded diagram showing a fore-edge painted book according to an embodiment of the invention;

FIG. 28 is a diagram showing two possible spine-printing patterns for a fore-edge painted book according to an embodiment of the invention;

FIG. 29 is an illustration of the pages of a book according to two possible further embodiments of the invention; and

FIG. 30 is an exploded diagram of a book according to a further embodiment of the invention.

### DETAILED DESCRIPTION OF EXEMPLARY EMBODIMENTS

The brief:
Design a book consisting of sheets of paper with printed buttons (links), which when touched allow the user to access and control digital information.
The information to be accessed is either stored locally (within the book) or remotely (PC, handheld devices, Web, other books). Remote communication happens wirelessly.
The book should feel and look like a regular book, thus allowing for flipping pages, making the implemented technology non-intrusive, while being portable and robust.
The technology and industrial design of the book should provide for a variety of content to be published in this way, without altering the manufacturing method. Manufacturing should be done based on traditional bookbinding techniques minimizing complexity and costs.

When we browse the web, the mouse pointer tells us where links are by becoming a “pointing-hand” symbol. This is replicated quite literally by the electronic book. Some examples of possible products that could be realized include:

### Childrens Books

These are the most immediately realizable application. Such an electronic book could contain childrens stories with interactive audio elements on it. A kid would browse through the book, look at the images and activate different sounds by touching on drawings or text. The music may be played back either through headphones connected to the spine of the book or transmitted wirelessly onto a PC.

Another example is educational books, where children learn phonetics by going over syllables with their fingers. The syllables are being spelled out, making learning a pro-active and fun experience.

Since books and paper are probably the most intuitive interface with numerous advantages compared to screens, keyboards and mice, children may learn to use computers or learn to browse the Web by touching hyperlinks printed on specially designed books. The same may be applied to older people as well and generally to people not accustomed or able to use computers.

Existing competition in this field includes LeapFrog pads, manufactured by LeapFrog of California, USA (price ca. £30). These are special-purpose, multisensory learning devices for children. Such products usually comprise a pad attached to a plastic base which houses the sensors and electronics. Thus it is not really portable, quite bulky, the pad itself is mostly not interactive and as with most electronic devices it is prone to damage.

### Books for the Sight-Impaired

People who experience sight disabilities or blindness resort to audio-book CDs to listen to story. What if these people could listen to the story by moving their index finger over the text, thereby activating each individual word or phrase? This way, one would be in total control of his/her reading speed, go easily forth and back in the book and generally get a much closer feeling to actually reading the book.

### Novels

Recent research suggests that readers of the ‘Da Vinci Code’ often interrupt their reading in order to search and find more information or images about a famous art piece or place that is mentioned in the story. It would be much more convenient and fun, if one could simply ‘Google’ a word just by touching a word that links it to relevant information on the Web.

### General Content Books

It is often the case today, that people are overwhelmed by the overflow of information that surrounds them, whether it is in digital or analogue form. Computers and books co-exist in our office spaces or homes in an unorganized way, making it extremely difficult to keep track of useful information that may be found on these various sources. With such an electronic book, it would be possible to ‘bookmark’ a chapter, a paragraph or a printed image by submitting the content of interest on any wireless enabled device (PC, PDA, mobile) to be stored. This way one can retrieve, keep track and make sense of information found anywhere on any book.

This concept may be extended in ‘collaborative authoring’ found for instance in Wikipedia, where one may submit whole exerts of text to the server, hence contributing to general knowledge.

### Software Manuals

Most people, when they need to learn e.g. a software package, they usually buy a manual which takes them through the program, requiring both reading the book and interacting with the mouse and keyboard at the same time. With an electronic book, one could control the software on the monitor just through the book by pressing their finger on printed buttons.

### Libraries

Books may be connected with each other in a library, each book being aware of the contents of others on neighbouring shelves. Each book may refer the reader who is interested in a particular topic to other books existing in the same space. A realistic application of this may lie in public libraries.

### Music Books

In order to support the possibility of commercialization of such books, we will examine a case study of a specific product, that could be introduced and be profitable today.

A music book is a hardcover book that stores and plays back digital media (music) using its paper pages with printed ink text and images as a touch interface. Such a variation of the electronic book is aimed towards both the book and music publishing industries: An edited collection of albums with a certain theme belonging to a specific publisher (Sony, Universal, Mc-Graw Hill etc.). For instance, a spread may contain the album cover artwork, text and graphics on one page and the track list printed with conductive ink on the other. This way a 200-page book could contain up to a 100 albums, potentially replacing the space-hungry plastic CD covers from our shelves with books in the future.

Alternatively, a book that contains the story of a music genre, music period etc. could be made. It would have the respective music tracks contained within the text for a complete user experience. Such books would be written, designed and edited either by the publisher or the artists themselves.

The technology and industrial design of the book provide for a variety of themes/content to be published in this way, without altering the manufacturing method. In fact, manufacturing of such a book is largely done using conventional and long-established printing and bookbinding techniques, as will be explained later.

The music is played back from a home stereo or headphones connected via an output-jack on the spine of the book. Alternatively, music can be transmitted wirelessly to a PC via a miniature chip transmitter integrated on the hardcover.

In contrast to books, the medium for music has seen many changes over the years from physical artefacts like LPs, CDs etc. to an abstract digital form stored on flash-memory chips that is progressively being distributed and sold from virtual stores. It is imaginable, that the music publishing industry will not sell physical products in the near future and record shops may become extinct. The days where the record itself with its artwork and printed information was a valuable item to process seem to be in the past.

Although currently no similar product exists, books and music can be found today to co-exist on the shelves of many book- and record shops. Today, products that combine text/story and music are usually available in books sold accompanied with a CD. In this case, no true interactivity and synchronicity exists between reading and listening. Also one requires a CD-player present to get the complete experience. Such an electronic book integrates these aspects in a compact, beautiful and flexible product. Books have been around for centuries and are accepted as probably the most intuitive and easy-to-use format for storing and displaying information.

Books are a flourishing industry, as is music. The latter, however, by making the transition to digital format and on-line purchase and distribution methods seems to be struggling to convince customers to buy their products, who tend to acquire the digital tracks any way they can instead for paying for it. One reason for that is that the customer doesn't get the printed material (cover art work, information, lyrics etc.) that they used to buy together with an album. The proposed book-concept, offers the music industry an additional physical product next to their digital one, as well as offers the book industry added functionality to theirs without altering their format.

### Competition:

Audio CDs mostly come in a plastic case with the attached booklet. From an object point of view the only interesting part is the booklet, which is often beautifully designed and contains useful information and artwork. The rest is usually just plastic. They retail at £7-15, due to falling selling numbers. The proposed product in a way puts the contents of the CD into the booklet, making it a more attractive option for customers and publishers.
Books come in all sorts of formats and qualities. Their retail price can reach up to £40-50 for some well designed hardcover publications. An interactive book, like the one proposed, containing 50 albums at a similar price is a very attractive option (50albums×£8 per album=£400!).
Books published as Audio CDs. They retail at approx. £25-40. User needs a CD player, making it not a portable option. Listening to a text is unlike reading, since one is not in control of the story (pace, flipping pages, quickly finding the part of interest).

The product addresses a quite big customer base, since it exists on the crossover between books and music. At the launch of this product it will probably appeal to a more specialist audience that appreciates quality when they purchase music. At a later stage, with costs reduced due to expansion of printing electronic technology, the product will come into the mainstream.

It is rather convenient, that today one often finds books and music under one roof (or under the same web-store). Examples are Amazon, Waterstone's, Blackwell, Virgin Megastores, HMV etc.

On the publishers' part, companies like Universal, Warner, Mc-Graw Hill and Sony (which also has a potential technological interest in the invention) are only some of the parties that could get involved. As mentioned, manufacturing is very similar to existing methods so existing manufacturers don't need big capital investments.

Furthermore, many innovative start-up companies and big-business are currently focusing their efforts and funding on the printable electronics market. A product like this could be a very appealing opportunity for them to demonstrate their new capabilities.

### Conductive Inks

The pages are printed with a combination of normal ink (for normal text, images) and conductive ink (for the links). When the user touches a link, the skin-due to its native conductivity-acts as a switch to close a circuit and thereby gives a command for a specific task to be executed by the micro-controller.

Conductive inks are printable using conventional techniques (screen-, offset, industrial ink-jet printing) allowing a circuit to be drawn or printed on a variety of materials including paper. It usually contains powdered silver and carbon, is a cheap way to print printed circuit boards (PCBs) and has been used extensively by the electronics industry for many years.

Lots of research and funding has led to the development of variants of conductive inks with different physical and optical properties (e.g. transparent inks) offering more flexibility to the graphic designer or editor of such books.

Silver based conductive ink was chosen for this specific application, mainly due to its high conductivity compared to other inks. The specific one under consideration is XZ250 conductive screen printing ink manufactured by Coates Inc, a subsidiary of Sun Chemical Group B.V., the Netherlands. This ink is used in the fabrication of membrane switches and flexible circuits.

In addition, it is suitable for printing into a variety of substrates (including paper), for automatic and semi automatic printing machines, and where quick drying is required.

Typical properties of Ink XZ250 26-8203 (Coates Inc.):

| | |
|---|---|
| Pigment | Silver |
| Medium | Thermoplastic Resins |
| Viscosity @ 25° C. (77° F.) | 30-50 poise |
| Shelf Life in sealed containers | 3 months |
| Solids (%) | 70 |
| S.G. (g/cm3) | 2.2 |
| Pencil Hardness | 3H-4H |
| Sheet Resist. @ 25 μm.(1.0 mm) | <0.012 Ohm/Sq.<21 Ohm/Sq. |
| dry film thickness | |
| Sheet Resist. @ 15 μm.(0.6 mm) | <0.020 Ohm/Sq.<35 Ohm/Sq. |
| dry film thickness | |
| Resistivity | 30 μOhm · cm |
| Theoretical Coverage | ~21 |
| (m2/kg @ 15 μm d.f.t.) | |

The procedure for screen-printing used is described in the following steps:
A negative and positive film is produced in reprographics.
The overlay is placed over the emulsion-coated screen, and then exposed with strong UV-light. The areas that are not opaque in the overlay allow light to reach the emulsion, which hardens and sticks to the screen.
The screen is washed off thoroughly. The areas of emulsion that were not exposed to light corresponding to the image on the overlay dissolve and wash away, leaving a negative stencil of the image attached to the screen.

Photographic screens can reproduce images with a high level of detail, and can be reused for thousands of copies.

Because conductivity is governed to a large extent by film-weight, a mesh that would give the best combination of conductivity and economy was selected. For this a mono-filament polyester meshes of 90 T/cm (230 T/inch) was used.

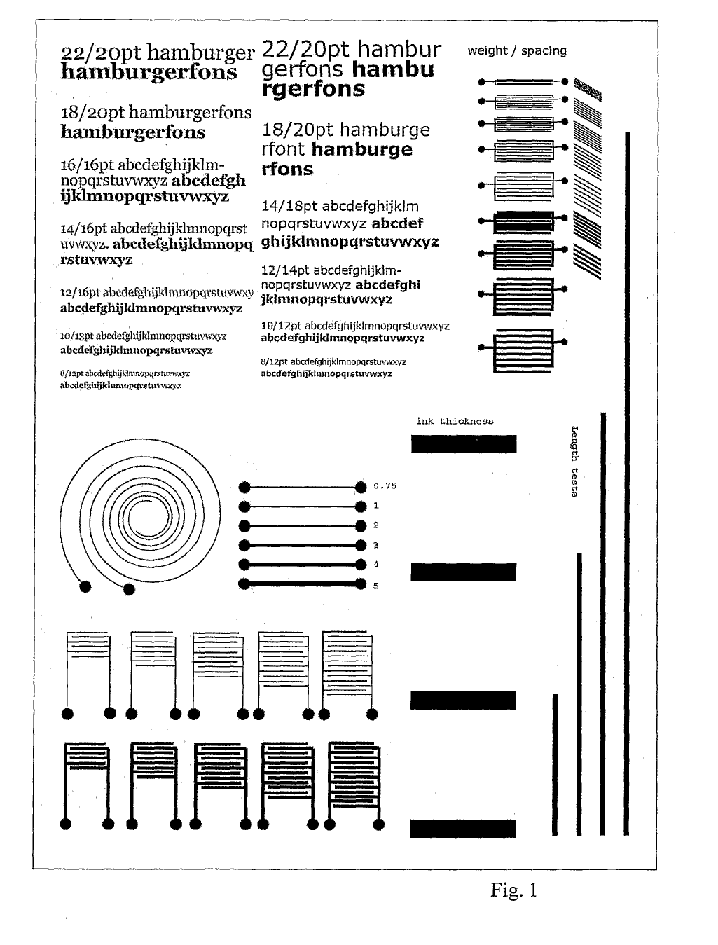

In order to validate the touch-switch interface, a variety of tests had to be carried out. FIG. 1 shows a test sheet that was designed to be screen-printed with the conductive ink in order to evaluate different parameters regarding print limitations and electrical characteristics of the ink printed on paper.

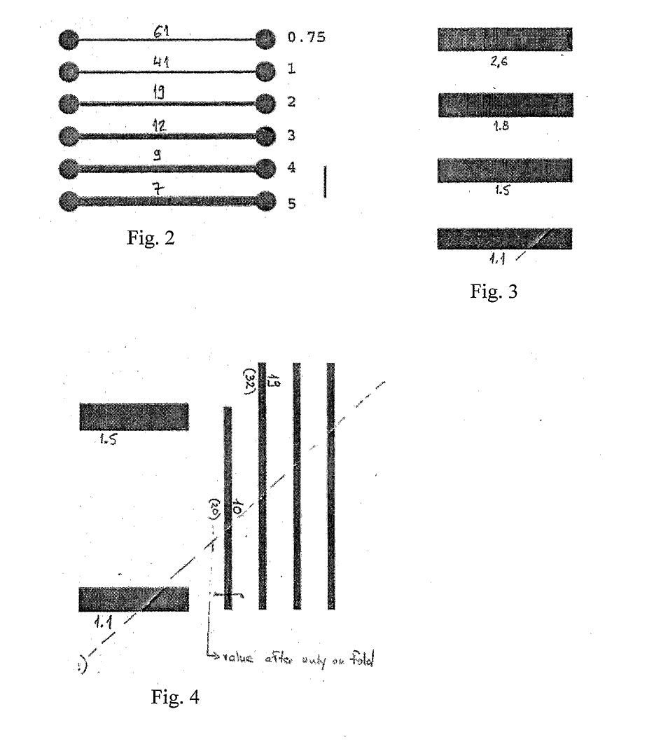

The test sheet was printed onto different kinds of paper. The paper varied in terms of quality (coated/uncoated) and weight like one finds in real books. The sheets were then evaluated using a multimeter. These measurements served as database that would eventually dictate the graphic design requirements of the circuit and switches to be printed onto the book's pages. Increasing line width, as shown in FIG. 2, decreases line resistance, as expected. Increasing line thickness by adding more layers of ink, as shown in FIG. 3, decreases line resistance. FIGS. 2 and 3 both show the values obtained during testing. These tests also showed potential limitations in terms of qualities of the substrate paper and issues relating to switch patterns.

The tests show that text up to 8/12 pt is printable with a good resolution.

Conductive inks are known to be brittle when bent. This might prove to be important in case of printing on flexible substrates like paper. For this reason the test pages were folded in their corners and new resistance measurements were made. A fold line is illustrated in FIG. 4, with the resistance before and after folding shown (the numbers in brackets are the resistance after one fold). These showed that the connection breaks after a couple of foldings. However, it was observed that thinner paper exhibit this problem to a much lesser extent than thick paper. This issue can be overcome also by printing the switches close to the spine where the bending of the paper from flipping the pages is less. In contrast, paper quality doesn't influence the electrical properties.

Although recent rapid growth in the printed electronics market (e.g. RFID tags) has the effect of lowering prices for conductive inks, silver-based ones are still relatively expensive. In the future, this could limit the possibilities of an electronic book printed solely out of conductive inks (e.g. every word is active). For this reason possible alternative materials were researched.

Conductive polymers are organic polymer semiconductors. Recent developments in industrial printing using organic materials such as intrinsically conductive polymers have opened the door to a whole new industry of making cheap disposable electronic gadgets for various purposes. Applications for conductive polymers are being seen in the area of intelligent packaging, electronic stamps, electronic bar codes, OLED displays, intelligent paper and much more.

Polymer electronics (often printed) are driven by some distinct benefits offered by this approach such as:
High volume production capability (printing) means very low unit prices and therefore disposable electronics
R2R (Reel to reel manufacturing)
Large area flexible devices possible
Organic materials
Low weight

Considering these factors, polymer based conductive inks like the ones used for making electroluminescent lights were considered as a possibility for printing whole books. Five polymer inks were tested. First the Baytron S V3, manufactured by HC Stark of Massachusetts, USA and then the Orgacon EL-P1000, EL-P3000, EL-P4000 and EL-P5000, manufactured by the Agfa-Gevaert Group of Mortsel, Belgium.

Test carried out in similar way with the silver inks, showed that:
Conductivity of these inks is much lower than the silver one. However, although the current that would reach the microcontroller is quite low, it would still be enough to drive the electronics.
They are not brittle; hence they don't break when the paper is folded.
They can be screen-printed using the same screens as the silver ink.
Print quality depends on the kind of paper used. While some inks are satisfactory on coated paper, others showed a better adhesion on uncoated. Overall print quality is lower than silver inks. The reasons may lie in the fact that most of them were originally intended for other substrates than paper (glass, plastics etc.) and that they require curing in claves.
While one ink was black, so the contrast is similar to normal ink on paper, most of them (especially the ones intended for paper substrates) have a faint blue/grey colour making it uncomfortable for the eyes.
They are still in development stage.

Until those inks become commercially widely available and are optimized specifically for printing text on paper, silver- or carbon-based conductive inks are proposed for such an electronic book. This is also supported by graphic design considerations, since these colours express the visual language of printed electronics, which is a conscious graphic design decision for this particular book.

However, the tests with polymer-based conductive inks have shown the feasibility of printing books solely with conductive inks in a more economical way.

### Switch Design (a Mix of Electrical & Graphic Design)

The proposed touch-sensitive switch concept is based on the principle that one's finger may act as a bridge to close an open circuit printed with conductive ink on the page. However, the resistance of the human skin (although it varies due to humidity and grease) is quite high to let a useful amount of current flow through the circuit.

To overcome this issue, touch-sensitive switches used in electronics were used as inspiration. The patterns on such switches are designed with the aim of distributing the resistance in a parallel configuration thereby lowering the overall resistance. If the same principle were applied to the printed switches on the page, one could theoretically achieve the same with the finger's resistance, thereby giving a higher current flow for the microprocessor. The most important single design objective is to provide as many shorting paths to the switch as possible.

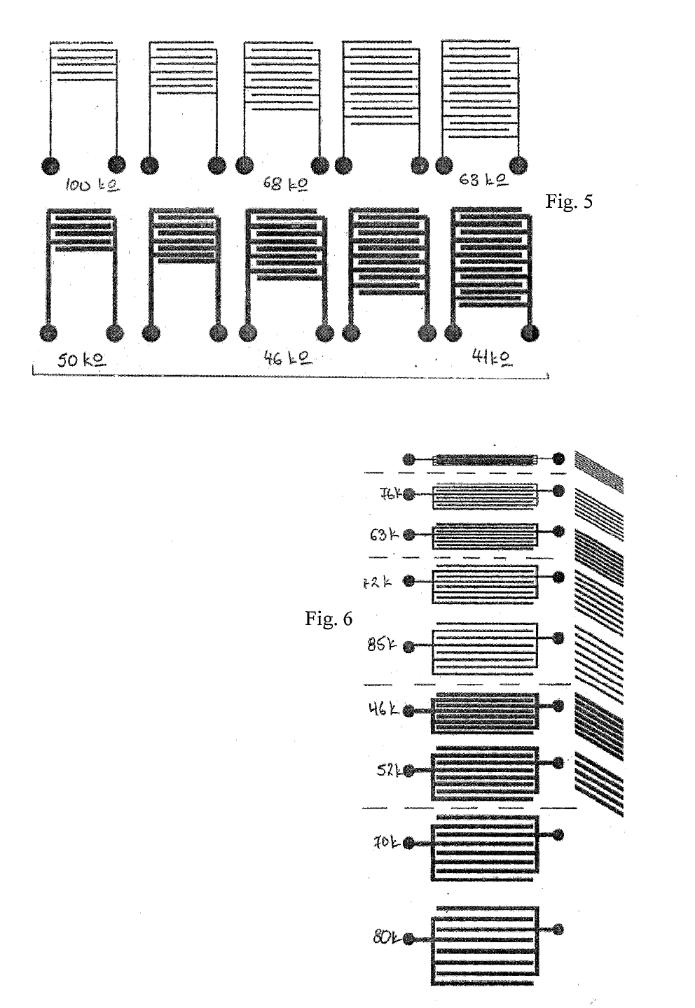

The same test sheet was used to validate this assumption and evaluate different parameters relating to the ‘switch-finger’ spacing, line width, number of ‘fingers’ etc. FIGS. 5 and 6 show printed patterns that were used to test whether resistance would change with line width. As expected, increasing the number of ‘fingers’ also gives better values. The values shown are qualitative since the results are dependent on finger pressure.

Smaller line spacing and larger line weight are desired to obtain a smaller switch resistance values. It is also evident that there is a limit to as to how narrow the switch-spacings that can be obtained by screen-printing are (the switch at the top of FIG. 5 is short circuited).

The tests also showed that the values are dependent on the applied pressure of the finger, thus one should not expect to get the same response every time the switch is pressed. This could prove to be a problem for the microcontroller since it won't receive a clear input current. As will be explained later, this issue has been overcome via electronic design.

However, these switches will be used as a user interface, next to a properly designed text contained in a book. For aesthetic reasons, and also in order to achieve a level of intuitiveness for the reader, the switch patterns (links) must be designed in graphic design terms. This particular aspect of the project is where the boundaries between electronics and traditional book design become unclear.

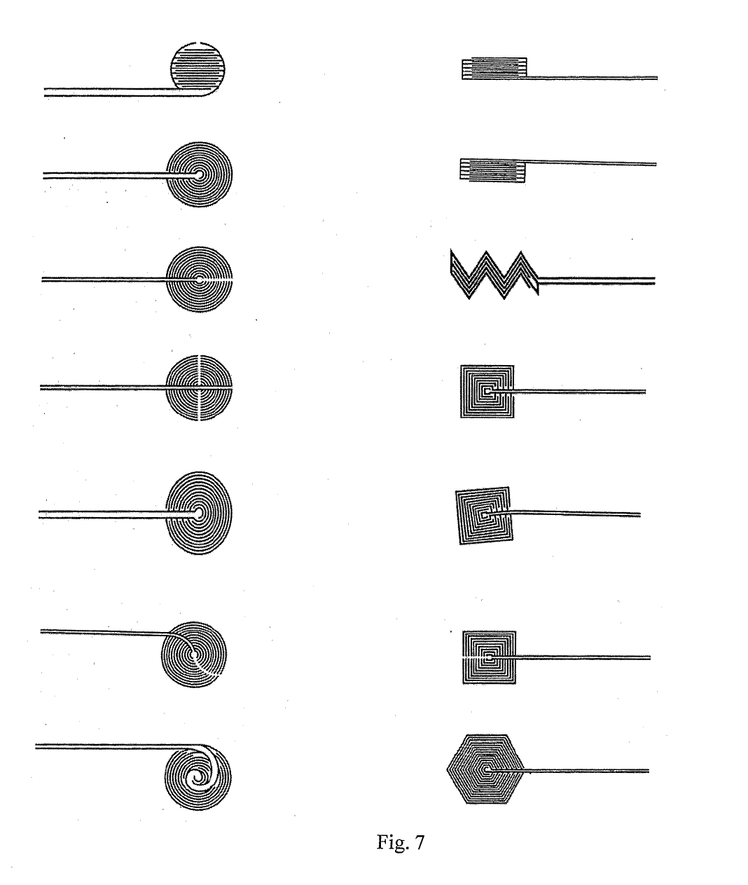

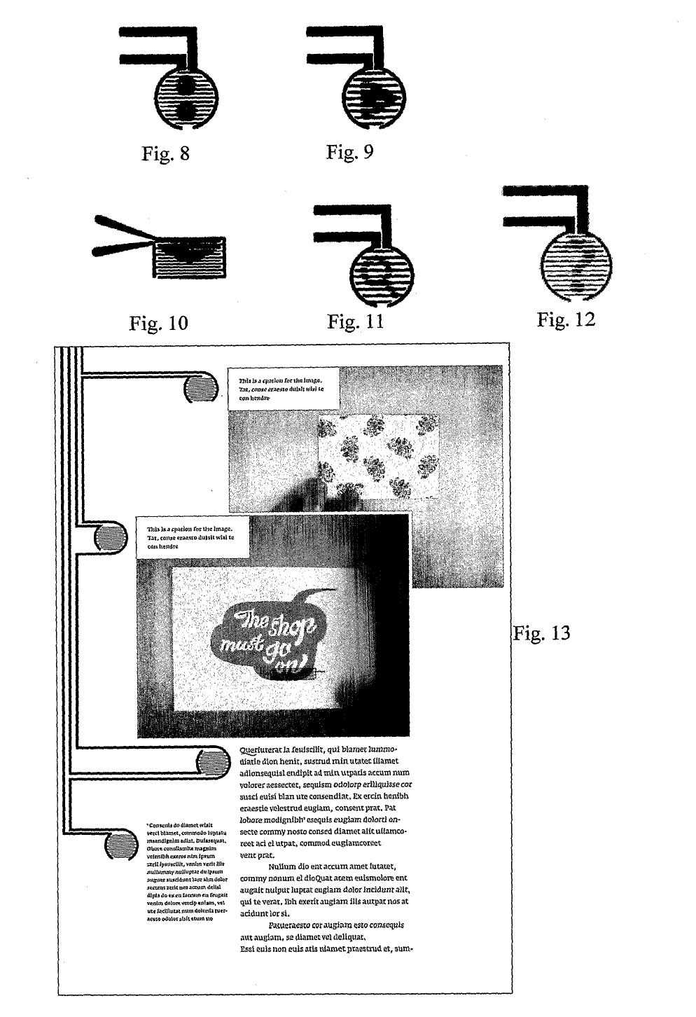

FIG. 7 shows a variety of different switch formats designed to be both aesthetic and functional. Intuitiveness in use is a major requirement. Therefore FIGS. 8 to 12 show a further development of switch designs. The new patterns try to convey their function in a way that will, at the same time, make the electrical operation feasible. A switch as illustrated in FIG. 9 would play a media file such as music or a movie. A switch as illustrated in FIG. 10 would send an email. A switch as illustrated in FIG. 11 would search for information on a word (“Googling” the word as mentioned above). Similarly, a switch as illustrated in FIG. 12 would get information about a topic, for example from Wikipedia.com.

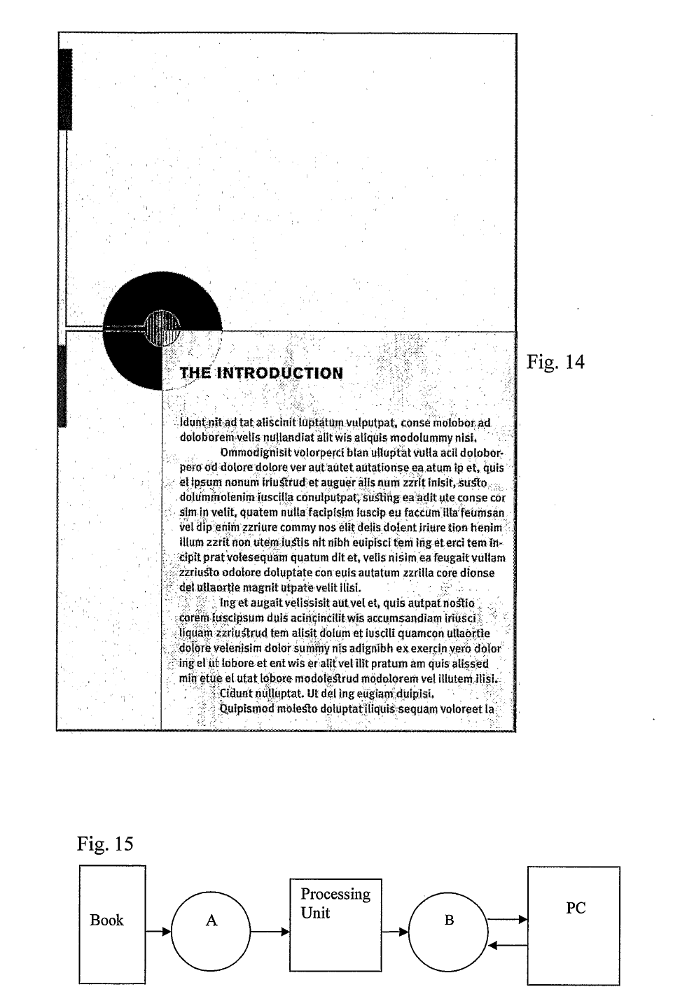

FIGS. 13 and 14 both show sample pages with switches with the connection lines in a real book context.

After finalizing the pattern design further tests were carried out to evaluate the limitations of line width and print resolution. Switches of certain line width proved to short circuit when screen-printed.

### Electronics

Most of the ‘electronic-book’ patents or similar available products, describe books which house the various electronic components (control circuit, batteries, speakers, buttons) in separate enclosures. These are either part of a base for the book to be placed on, in order to work or they are integrated inside the book replacing part of the paper area (e.g. top part of the book) with a bulky plastic housing.

The design of this book suggests that the electronics be placed inside the hardcover, which serves as a sleeve for protection and keeping them invisible. The electronics are mostly printed on thin flexible substrates and integrated inside the hardcover and spine making the technology non-intrusive and less distracting. This also makes the book very resistant to damage when used under ‘regular book conditions’. The user never comes in contact with these parts, keeping the user experience as close to holding, reading and browsing a regular book where the only activity on his/her part is limited to touching printed text.

The proposed conductive ink technology is also conveniently suitable for printing electronic components on thin flexible substrates, a technology that is currently on the forefront of electronics innovation, for instance in smart labelling on paper packages, RFID technology etc. In the next couple of years, one can expect whole circuits, switches or even speakers to be printable on very small areas using conventional printing techniques.

In cases where the electronic book is autonomous (e.g. books that contain music, childrens' books for phonetics etc.), the digital data (mp3, etc.) is stored on a flash memory chip inside the book.

In short, the Printed Circuit Board (PCB) that will be placed inside the cover will carry the microcontroller (PIC), the wireless module and antenna (Bluetooth) and batteries.

### Objective:

Design and implement an interface between the interactive book and a PC. Communication between the book and other devices will be based on the same principles.

### Specifications:

The PCB should be small enough to fit in the cover of a book.
The circuit shouldn't require more than 3-3.5 Volts (two small flat batteries).
The design should be easily adaptable to be used in any Bluetooth enabled device.

The interface as well as the processing unit will be micro-controller based. The choice of an embedded solution is firstly 80% dependent on code and secondly, it will be flexible in terms of firmware updates to encapsulate new functions as well as improving the actual interactivity. A PIC microcontroller (the PIC16F877/874) was chosen for this task.

In practice there are two interfaces to be implemented, interface A and interface B, as shown in FIG. 15.

Interface A will be responsible for connecting the book efficiently with the central processing unit. The design task is to be able to implement a solution that takes into account all possible physical or electrical characteristics of the interactive book.

At first the ‘touch sensitive switch’ has to be implemented, which will ensure that no matter what the conditions are (physical or environmental), touching a link on any page of the book will trigger an event on a PC.

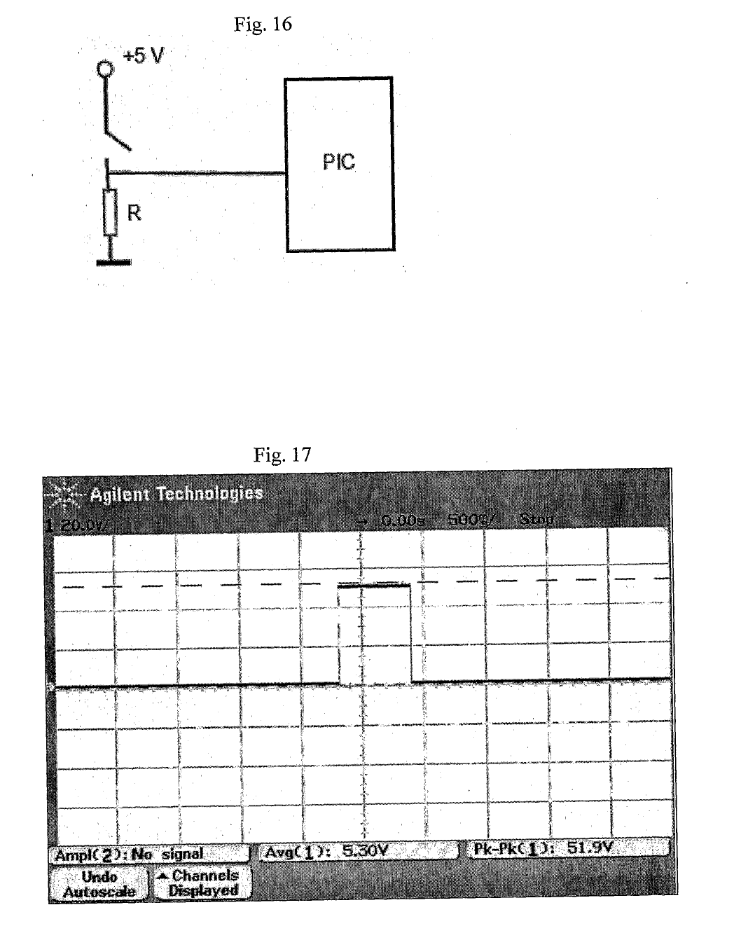

There are several methods that can be used to implement the touch sensitive switch. The most reliable, simple and effective one will be used. The principle of the touch sensitive switch chosen is illustrated in FIG. 16.

The page consists of a certain number of links or “switches” (the first prototype that was tested and is described here uses 4 links). These switches are not ideal, meaning that an ideal switch would have zero Ohm resistance. The switches used for the book have an ON resistance that depends on the individual's skin impedance, which in practice varies from few Ohms (wet fingers) up to 300K (room temperature clean fingers).

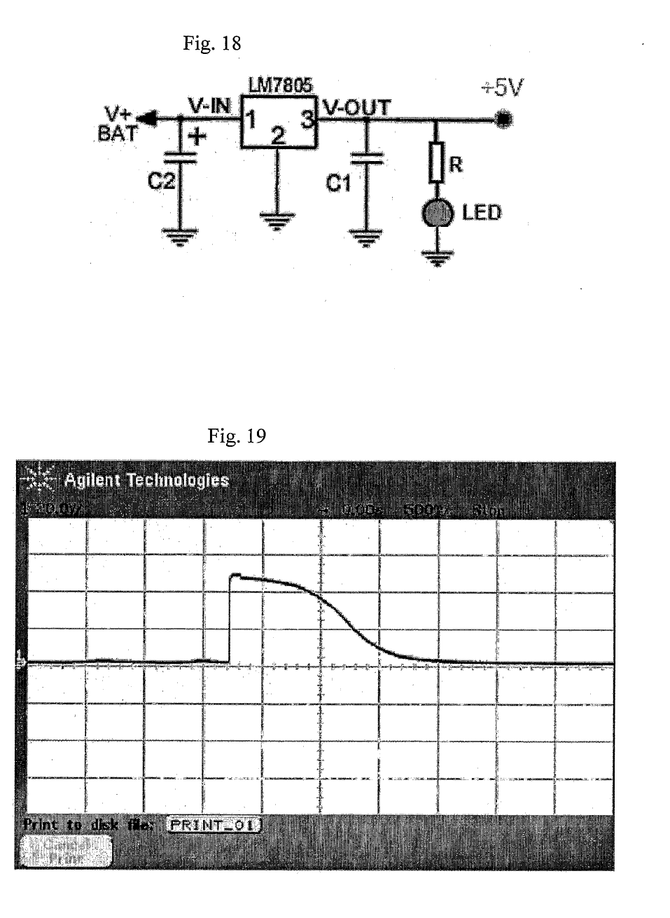

The input to the PIC should ideally look like FIG. 17. To evaluate the actual response upon touching a link we developed a prototype circuit board as shown in FIG. 18, in which C1=C2=0.1 uF (Tantalum), R=330 and Vin is a 9V battery. The page was connected to the cables using staples. Each link on the page (4 in total) activates a separate LED and activates a sound. The tests revealed the response shown in FIG. 19, which it is difficult for the microcontroller to recognise as it is not a clear signal. As well as skin conductivity, this response is influenced by other glitches that are due to noise.

This issue was resolved by implementing a debouncer which transforms the real input signal into an ideal one. This solution can be implemented in two ways, hardware or software. The software solution is more attractive since a PIC was used.

A software debouncer simply introduces a delay (40 ms in our case, which can be reduced to 20 ms) that will actually eliminate any spurious signals that might be generated as a result of enabling the switch. The debouncer code used is shown in appendix 1.

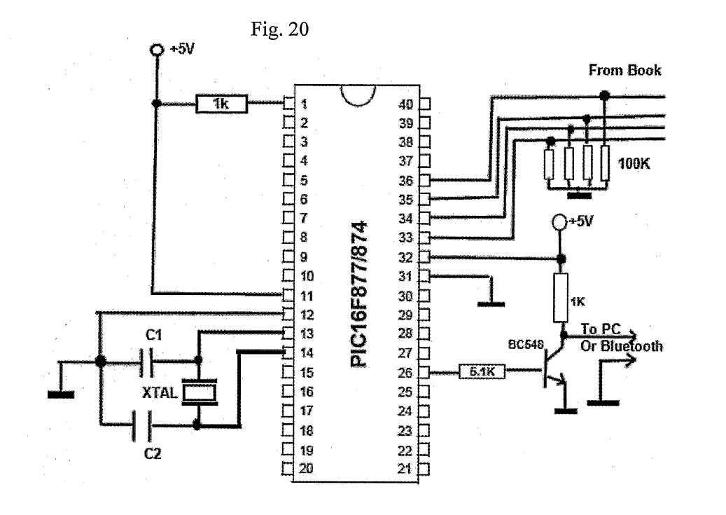

When the PIC detects that a link has been activated, an ASCII character is generated and then sent to the output interface. For this prototype we used simply Character “1” for link No. 1 and Character “2” for link No. 2. The complete main circuit board is illustrated in FIG. 20 and the complete PIC Code can be found in appendix 2.

The output from the PIC is a UART (Universal Asynchronous Receiver/Transmitter). We will use only the Tx output, since we're just transmitting data. This can be connected directly to an RS232 PC interface, which nowadays is disappearing from portable computers and being replaced by USB, Bluetooth, FireWire, etc.

In this case we will be implementing a Bluetooth connection because it's wireless and widely available in portable and handheld computers. The Bluetooth module to be implemented (the uIceBlue from Emxys of Alicante, Spain) is an embeddable control module based on the PIC16F877 microcontroller, like the one used in the prototype board.

The board offers in a double row pin connector to the PIC16F877 pin out. This allows us to implement almost any application previously developed for the PIC16F877 with no constraints using Bluetooth serial communications with no glue code or electronics required. Another advantage of this particular module is its small size and the fact that it is driven by a low-power (3.3 Volts). The characteristics of the module are:

| Specification | Data |
|---|---|
| Power supply | 3.6 ± 0.1 V DC |
| | Maximum Rating Vcc <12 V DC |
| | (Vcc limited by included LDO regulator) |
| Current consumption | 150 mA maximum |
| Internal Operation | +3.3 V |
| Voltage | |
| IO digital Pin voltage/ | 3.3 V/20 mA (maximum) |
| sink/supply current | |
| Analog input: voltage | 0 to +5 V ± 0.8 V (Vref += Vdd, Vref −= Vss) |
| range | |
| Analog input: Input | Zᵢₙ < 10 KΩ |
| impedance | |
| Size | 54.3 × 26.2 mm |
| Environmental | −40° C. to +70° C., 5-95% humidity |
| | non condensing |
| Carrier Frequency | 2402 MHz to 2480 MHz |
| Radio Power | 14 dBm (Class 1) |

A PC software application has also been designed, and is shown in appendix 3. The role played by this application is to translate the characters received from the interface into actions, such as:
Playing a Media file.
Opening a Picture.
Sending an email.
Searching the internet.
etc.

The application was developed using Delphi (Turbo Pascal), combined with an access database where each link-action is programmed and saved.

### Bookbinding

One of the main design specifications for the book described here is that it should be mass-manufacturable in a way that is close as possible to traditional book manufacturing techniques. As shown above, printing the pages can be done using conventional screen- or offset-printing techniques both for the regular and ‘interactive’ text.

However, the main challenge lies in the binding of the active pages into a format that resembles a real book and in a way that allows for a connection to the electronics on the cover. Any attempts until now to realize such electronic books have led to awkward book formats, more electronics and more switches. Such approaches raise costs and require investments in new manufacturing facilities. In addition, they make reading a rather unfamiliar activity.

The technology, format, materials and overall design of this book should resemble a regular hardcover book, in order to keep the reading/holding a book experience non-intrusive and intuitive. As already mentioned, existing patents and available electronic books require the user to get used to different buttons and switches making it a rather awkward experience.

One further design requirement set for this book was for the proposed technology and industrial design of the book to provide for a variety of themes/content to be published without altering the manufacturing method.

Binding the book is the last and most important step for realizing such a book. Most attempts by designers or companies until this point haven't produced a simple, economical and non-intrusive way to do this. This is why I have resorted to traditional and long-established bookbinding techniques as a way to keep manufacturing costs low, making manufacturing by any bookbinder simple and keeping the design ‘book-like’.

The proposed design will make use of various established bookbinding techniques like section-bound, perfect-bound, Japanese binding, oversewing, etc. to achieve the above mentioned goals. Also the materials of this book should be mostly identical to the familiar hardcover (codex).

A number of techniques for incorporating electrical connections into bookbinding have been explored, and are set out below.

In Japanese bookbinding technique the book is bound with a thread at different points giving a very strong bind. A modification of this technique is shown in FIG. 21; each bound section of the book is sewn in ca. 15 separate segments, each one connecting one hyperlink via its thread 1 to the circuit on the spine. The threads are conductive (normal thread dipped in conductive ink or thin copper wire) allowing the signal coming from the page to be transmitted to the spine and the electronics. Such a method doesn't require other elements foreign to books to be part of it in order to achieve the same goal.

It was soon proven that the main difficulty with this and similar approaches was to ensure a connection between the printed ink trace on the page, and the thread which is inserted laterally to the page's surface. The hole where the thread is inserted doesn't provide a reliable connection.

A further method researched for binding the book was the most-common ‘section-binding’. Section-bound books are divided in spread-sections bound together either with a thread or staples.

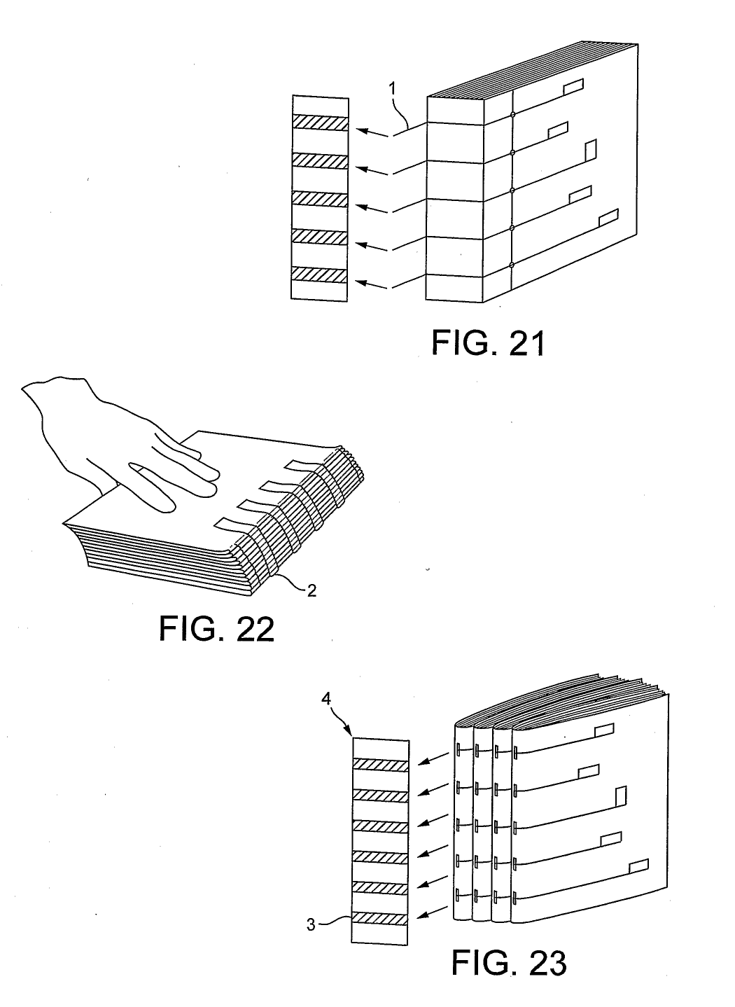

The idea is that each staple (or conductive thread knot) is connected to an individual link within each section of the book. This way the number of total links possible for such a book is dictated by the number of staples of each section, the number of spreads that each section binds together and the number of sections within the book. FIG. 22 shows an example; the staples in this case are connected to the PCB using conductive thread or tape 2.

A further iteration of this concept, shown in FIG. 23, proposes using a conductive glue, screen-printed onto fabric 3 that would bind the spine 4 together. Once bound together, the conductive glue traces would fall onto the stapling areas also providing the connection to the PCB on the spine.

The main problem with this method is again to ensure a connection between the printed ink trace on the page, and the thread which is inserted laterally to the pages surface. A sewing method to overcome this was developed. This method proposes for the thread to be sewn at an angle on each spread so one can always ensure a connection with the paper.

In one variant of this approach, each contact point on each spread is punched with the same number of holes as the number of spreads. The thread follows a lateral and parallel route between the spreads and may be repeated as many times as desired to make sure there is always a connection.

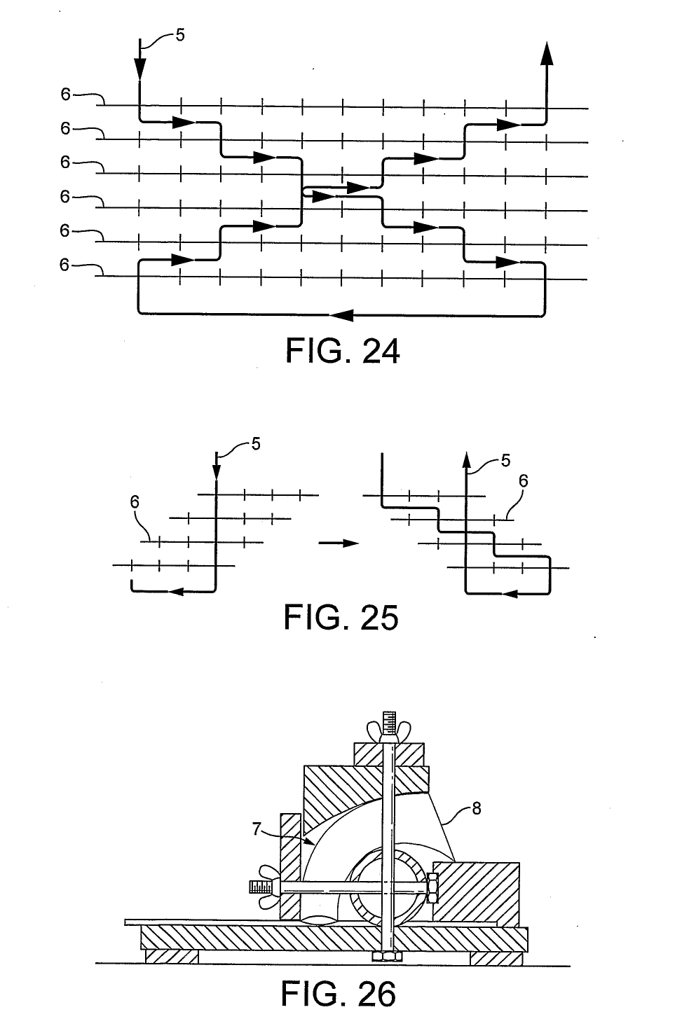

FIG. 24 shows one route for the thread 5 through the spreads 6, when actually more variants of the same principle are possible. FIG. 25 illustrates the industrial manufacturing procedure, where each spread 6 is moved sideways relative to each other allowing the thread 5 to move laterally, as is the case with sewing machines.

Spreads were printed with links on them in order to be bound together with the conductive thread. Initially, thread was dipped in conductive ink. It was proven, however, that conductivity is not assured along the whole thread. Also the ink proved to be brittle when the thread was bent for sewing. For this reason, silver-based conductive thread, like the one used for wearable electronics was used. This thread is highly conductive and physically similar to conventional thread.

This method uses only traditional materials and tools for binding the book together. Testing showed that the method works, hence touching a link onto any page of a bound section would give an output on the according thread connected with it. However, one problem with this technique proved to be the fact that sewing and then tightening the sections together might damage (rip) the paper at the contact points. For this extra care is needed.

Although, it was shown that such an electronic book is possible to make using conventional bookbinding techniques, in a relatively easy way, certain issues still remained open:
An arbitrary number of links is not possible with the previous methods although a large number is possible.
Reliability of connections is not always guaranteed.
While minimal, manufacturing would still require some equipment investments for industrial production.

Looking for an optimal solution, I researched further and found inspiration in an old English 18th century craft used for decorating books. Fore-edge painting is still used today by a limited number of artists to decorate the fore-edge of the book with a painting. The painting is visible only once the book is bent. For this reason the painting is done in the same position using a special tool which is shown in FIG. 26, where the pages of a book 7 are held in a bent position to expose the painting surface 8.

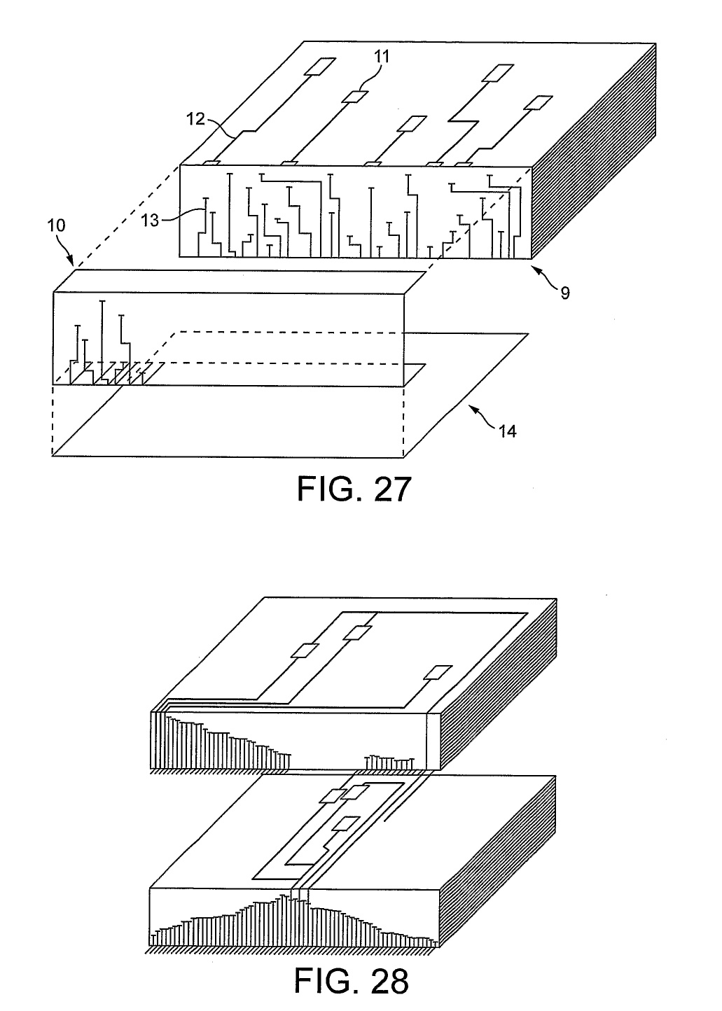

This concept adapted to the electronic book is illustrated in FIG. 27. The book is ‘perfect-bound’, thus there are no bound section or spreads. ‘Perfectbinding’ is one of the most commonly used bookbinding techniques. The pages are individually cut and glued on the spine 9. The whole book is bound together with a piece of fabric 10 screen printed with conducting ink and also glued on the spine. The links 11 are led to the edge of the paper (towards the spine) via the connection lines 12 of conducting ink.

A connection line 13 of conducting ink is either drawn on to the spine-edge using the same fore-edge painting technique or the lines are screen-printed onto the fabric. These lines are then led to the hardcover 14 and the PCB.

FIG. 28 shows two possible printed spine patterns.

This way, each individual link has a unique connection line leading to the PCB, thereby having a unique ID in the microcontroller. Obviously, the number of links within one book is only limited by the number of thin connection lines along the spine. The previously described screen-printing tests showed that very thin lines can be printed onto the fabric. This way the height of the book will determine the maximum number of links, it is however, possible to have several thousands of them by combining this technique with the appropriate electronics design.

The fore-edge painting method was tested on a book-dummy to test whether one can achieve an uninterrupted connection. One thing that became apparent is that the ink traces along the edge of the spine could break when the book is opened. To overcome this, PVA glue was applied along the spine to eliminate the danger of brittle breaking. Followingly, the connection lines were drawn, PVA glue was applied, the book was bound and cables were connected to lead to the microcontroller. Initial test showed the method working, thus one can flip pages, touch a link with their finger and get a signal outside the book. The book was then connected to the electronics board which was programmed to link each ‘switch’ to a unique LED. This particular dummy had only two links and two lines along the spine, but it clearly demonstrated that more links are possible.

Applying the PVA glue on the spine section is a very important part for making ‘perfect-bound’ books. The glue is ultimately what keeps the pages together in that case. That raised a problem for the proposed technique, because if the glue is applied before the ink traces are drawn on the spine then this will electrically insulate the connections. If applied after, one can only apply the glue between the connection lines, which in the case of many thin lines on the spine would be problematic. Looking at ways to optimize the method a modification to drawing lines onto the spine was invented.

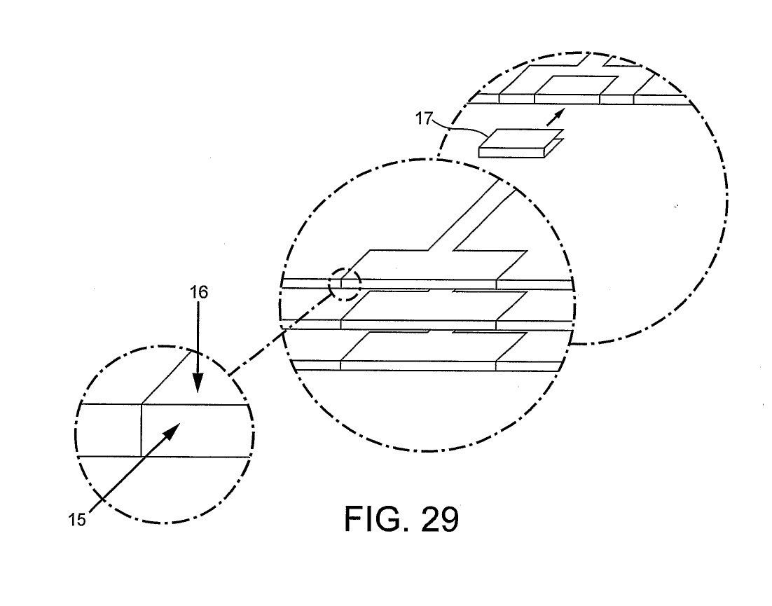

During screen-printing of the pages, the ink is allowed to ‘bleed’ along the papers edge. Then the paper is flipped to the other side and the same contact pattern is printed on the same spot and the ink let again to bleed on the thin edge. As is shown in FIG. 29, the paper edge 15 (spine) is painted with ink by screen-printing on top 16 and letting the ink leak on the edge. Alternatively, a metal clip 17 can be used.

Doing the same for each paper of the book provides a continuous connection line leading to the cover and the PCB. This method is by far the most easy, reliable, cheap and elegant from the ones developed up to this point. Binding the pages together will be done using the previously described Japanese technique, as an alternative to glue. This ensures a strong bound book and an elegant book design.

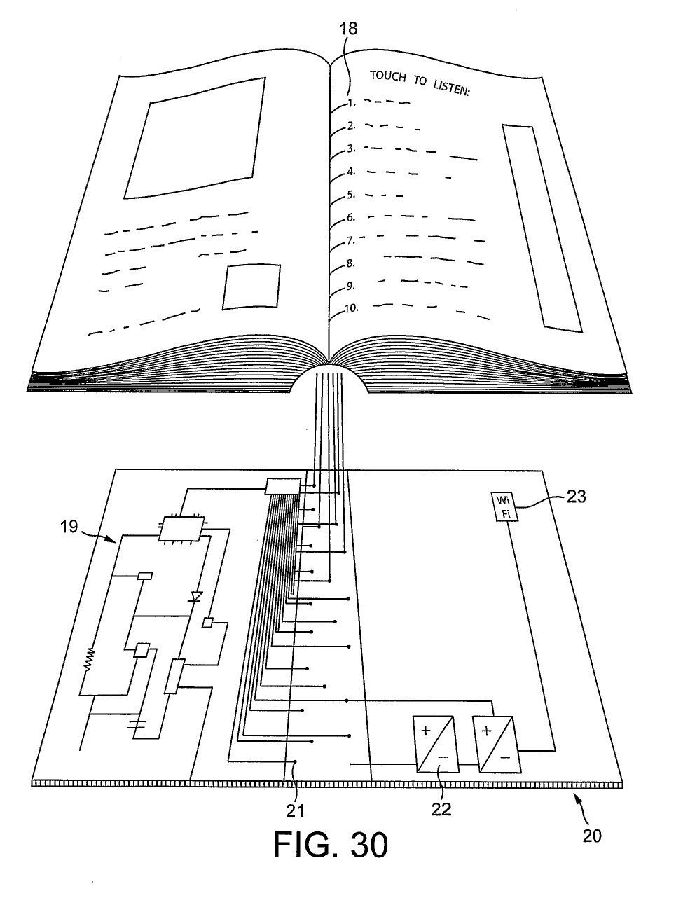

FIG. 30 shows a book according to the invention. The book provides hyperlinks 18 which connect to printed electronics 19 in the book's cover 20 via contact points 21. The book is also provided with paper batteries 22 for power and a WiFi device 23.

APPENDIX 1
Debouncer Code

| ;**************************************************** | | | |
|---|---|---|---|
| ; Debounce, wait a while - quick and dirty way of doing things!! | | | |
| Debounce | | | |
| | banksel Deb_Counter | | ; select correct bank |
| | movlw | .5 | |
| | movwf | Deb_Counter | |
| deb_loop | | | |
| | call | Delay | ; wait aprox. 40mS |
| | decfsz | Deb_Counter,f | ; are we finished |
| | goto | deb_loop : do again | |
| | return | | |
| :***************************************************** | | | |
| ;************************************* | | | |
| ; Delay , wait a while! approx 40mS | | | |
| Delay | | | |
| | banksel | DLY_temp1 | |
| Dly1 | decfsz | DLY_temp1 | ; dec inner loop |
| | goto | Dly1 | |
| | decfsz | DLY_temp2 | ; dec outer loop |
| goto | Dly1 | | |
| | return | | |

;****************************************

APPENDIX 2
PIC Assembly Code

;**************************************************
; Book button scan routine

| | |
|---|---|
| list p=16f877 | ; Specfies the device used (for MPLAB) |
| include “p16f877.inc” | ; Register map for 16f877 |

;*************************************
; equate system variables

| | | | |
|---|---|---|---|
| TX_data | equ | 0x30; | ; transmit data buffer |
| DLY_temp1 | equ | 0x31; | ; delay counters |
| DLY_temp2 | equ 0x32; | | |
| Button_Flags | equ | 0x33 | ; button status flags |
| Deb_Counter | equ | 0x34 | ; debounce counter |

;************************
; Define button inputs and LED outputs

| | |
|---|---|
| #define Butt1 | PORTB,1 |
| #define Butt2 | PORTB,2 |
| #define Butt3 | PORTB,3 |
| #define Butt4 | PORTB,4 |
| #define LED1 | PORTC,4 |
| #define LED2 | PORTC,5 |
| #define LED3 | PORTC,6 |
| #define LED4 | PORTC,7 |

; define button flags

| | |
|---|---|
| #define Butt1_Flg | Button_Flags,0 |
| #define Butt2_Flg | Button_Flags,1 |
| #define Butt3_Flg | Button_Flags,2 |
| #define Butt4_Flg | Button_Flags,3 |
| ; define beep output | |

| | | |
|---|---|---|
| #define | Beep_OP PORTC,4 | ; sounder output bit |

;*************************************

| Start | | | |
|---|---|---|---|
| | org | 0x0000 | ; Program must start at the reset vector |
| | nop | | ; Needed because we are using the ICD |
| | goto | MAIN | |
| | ;; jump over int vector | | |
| | org 0010 | | |
| MAIN | | | |
| | banksel | TXSTA | ; select correct bank |
| | movlw | 0x26 | |
| | movwf | TXSTA | ; set up usart for 8 bits |
| | banksel | SPBRG | ;select correct bank |
| | movlw | .129 | |
| | movwf | SPBRG | ; set baud rate to 9600 |
| | banksel | RCSTA | ; select correct bank |
| | movlw | 0x80 | |
| | movwf | RCSTA | ; enable the usart |
| | banksel OPTION_REG | | |
| | movlw | 0x87 | ; select pull ups off |
| | | movwf | OPTION_REG |
| | banksel TRISB | | ;select correct bank |
| | movlw | 0xff | |
| | movwf | TRISB | ;; set portb as inputs |
| | clrf | TRISC | ; set port c as output |
| | banksel | PORTB | |
| | movlw | 0xff | |
| | movwf | PORTC | ; turn off all leds (active low) |
| | clrf | Button_Flags | ; clear all flags |

;**************************************************

| | | | |
|---|---|---|---|
| Main_Loop | | | |
| | banksel | PORTB | |
| | btfsc | Butt1 | ; test button 1 |
| | call | Butt1_Act | |
| | btfsc | Butt2 | ; test button 2 |
| | call | Butt2_Act | |
| | btfsc | Butt3 | ; test button 3 |
| | call | Butt3_Act | |
| | btfsc | Butt4 | ; test button 4 |
| | call | Butt4_Act | |
| | call | Debounce | ; wait 200mS |
| | goto | Main_Loop | |

;/\/\/\/\/\/\/\/\/\/\/\/\/\/\/\/\/\/\/\/\/\/\/\/\/\/\/
;********* Button 1 action

| Butt1_Act | | | |
|---|---|---|---|
| | call | Debounce | ; wait, then retest button |
| | banksel | PORTB | ; select correct bank |
| | btfss | Butt1 | ; retest button 1 |
| | return | | ; button not true,return |
| | banksel | Button_Flags | |
| | btfso | Butt1_Flg | ; test previous button status 1=on |
| | goto | Butt1_off; button pressed for 2nd time, turn off | |
| | bsf | Butt1_Flg | ; set flag to indicate on status |
| | bcf | LED1 | ; turn on led 1 |

| | | |
|---|---|---|
| movlw | ‘1’ | ; load char A |

| | movwf | TX_data | |
|---|---|---|---|
| | call | TX_char | ; send char |
| | call | Beep | |
| | call | Debounce | ; wait 200mS |
| | return | | ; exit routine |
| Butt1_off | | | |
| | ;bcf | Butt1_Flag | ; set flag to indicate off status |
| | clrf | Button_Flags | |
| | bsf | LED1 | ; turn on led 1 |
| | movlw | ‘0’ | ; load char A |
| | movwf | TX_data | |
| | call | TX_char | ; send char |
| | call | Beep | |
| | call | Debounce | ; wait 200mS |
| | return | | |

;********* Button 2 action

| Butt2_Act | | | |
|---|---|---|---|
| | call | Debounce | ; wait, then retest button |
| | banksel | PORTB | ; select correct bank |
| | btfss | Butt2 | ; retest button 2 |
| | return | | ; button not true,return |
| | banksel | Button_Flags | |
| | btfsc | Butt2_Flg | ; test previous button status 1=on |
| | goto | Butt2_off; button pressed for 2nd time, turn off | |
| | bsf | Butt2_Flg | ; set flag to indicate on status |
| | bcf | LED2 | ; turn on led 2 |
| | movlw | ‘2’ | ; load char A |
| | movwf | TX_data | |
| | call | TX_char | ; send char |
| | call | Beep | |
| | call | Debounce | ; wait 200mS |
| | return | | ; exit routine |
| Butt2_off | | | |
| | ;bcf | Butt2_Flag | ; set flag to indicate off status |
| | clrf | Button_Flags | |
| | bsf | LED2 | ; turn on led 2 |
| | movlw | ‘0’ | ; load char A |
| | movwf | TX_data | |
| | call | TX_char | ; send char |
| | call | Beep | |
| | call | Debounce | ; wait 200mS |
| | return | | |

;********* Button 3 action

| Butt3_Act | | | |
|---|---|---|---|
| | call | Debounce | ; wait, then retest button |
| | banksel | PORTB | ; select correct bank |
| | btfss | Butt3 | ; retest button 3 |
| | return | | ; button not true,return |
| | banksel | Button_Flags | |
| | btfsc | Butt3_Flg | ; test previous button status 1=on |
| | goto | Butt3_off; button pressed for 2nd time, turn off | |
| | bsf | Butt3_Flg | ; set flag to indicate on status |
| | bcf | LED3 | ; turn on led 3 |
| | movlw | ‘3’ | ; load char A |
| | movwf | TX_data | |
| | call | TX_char | ; send char |
| | call | Beep | |

| | | |
|---|---|---|
| call | Debounce | ; wait 200mS |

return

;********* Button 4 action

| Butt4_Act | | | |
|---|---|---|---|
| | call | Debounce | ; wait, then retest button |
| | banksel | PORTB | ; select correct bank |
| | btfss | Butt4 | ; retest button 4 |
| | return | | ; button not true,return |
| | banksel | Button_Flags | |
| | btfsc | Butt4_Flg | ; test previous button status 1=on |
| | goto | Butt4_off; button pressed for 2nd time, turn off | |
| | bsf | Butt4_Flg | ; set flag to indicate on status |
| | bcf | LED4 | ; turn on led 4 |
| | movlw | ‘4’ | ; load char A |
| | movwf | TX_data | |
| | call | TX_char | ; send char |
| | call | Beep | |
| | call | Debounce | ; wait 200mS |
| | return | | ; exit routine |
| Butt4_off | | | |
| | ;bcf | Butt4_Flg | ; set flag to indicate off status |
| | clrf | Button_Flags | |
| | bsf | LED4 | ; turn on led 4 |
| | movlw | ‘0’ | ; load char A |
| | movwf | TX_data | |
| | call | TX_char | ; send char |
| | call | Beep | |
| | call | Debounce | ; wait 200mS |
| | return | | |

;*******************************
; TX_char transmit a characted via rs232

| | | | |
|---|---|---|---|
| TX_char | | | |
| | call | TX_send | |
| | movlw | .32 ; space | |
| | movwf | TX_data | |
| | call | TX_send | |
| | movlw | .13 | ; carriage return |
| | movwf | TX_data | |
| | call | TX_send | |
| | call | Delay | ; wait |
| | return | | |

;**********************

| TX_send | | | |
|---|---|---|---|
| | banksel | TXSTA ; | select correct bank |
| TX_snd1 | btfss | TXSTA,TRMT | ; test for transmit |
| | goto | TX_sud1 | ; still transmitting |
| | banksel | TX_data | |
| | movfw | TX_data | ; get char for transmition |
| | movwf | TXREG | ; send char (in same bank) |
| | banksel TXSTA | | ; select correct bank |
| TX_snd2 | | | |
| | btfss | TXSTA,TRMT | ; test for char sent |

; data sent, exit routine

| | |
|---|---|
| banksel PORTC | ; reset to bank 0 on exit |
| return | |

;*************************************
; Delay , wait a while! approx 40mS

| | | | |
|---|---|---|---|
| Delay | | | |
| | banksel | DLY_temp1 | |
| Dly1 | decfsz | DLY_temp1 | ; dec inner loop |
| | goto | Dly1 | |
| | decfsz | DLY_temp2 | ; dec outer loop |
| | goto | Dly1 | |
| | return | | |

;****************************************
; Debounce, wait a while - quick and dirty way of doing things!!
Debounce

| | banksel Deb_Counter | | ; select correct bank |
|---|---|---|---|
| | movlw | .5 | |
| | movwf | Deb_Counter | |
| deb_loop | | | |
| | call | Delay | ; wait aprox 40mS |
| | decfsz | Deb_Counter,f | ; are we finished |

| | |
|---|---|
| goto | deb_loop ; do again |
| | return |

;***********************************************
; Beep, make a noise! make use of the Delay and Deb. counter variables

| | | | |
|---|---|---|---|
| Beep | | | |
| | banksel | Deb_Counter | ; select correct bank |
| | movlw .0 | | |
| | movwf | Deb_Counter | ; load duration of tone |
| Bp1 | | | |
| | movlw | 0x02 | |
| | movwf | DLY_temp2 ; | set outer loop time |
| ; do on cycle | | | |
| | bcf | Beep_OP | ; turn sounder on |
| Bp2 | | | |
| | decfsz | DLY_temp1 | ; dec inner loop |
| | goto | Bp2 | |
| | decfsz | DLY_temp2 | ; dec outer loop |
| | goto | Bp2 | |
| ; now do off cycle | | | |
| | movlw | 0x02 | |
| | movwf | DLY_temp2 | ; set outer loop time |
| | bsf | Beep_OP | ; turn sounder off |
| Bp3 | | | |
| | decfsz | DLY_temp1 | ; dec inner loop |
| | goto | Bp3 | |
| | decfsz | DLY_temp2 | ; dec outer loop |
| | goto | Bp3 | |
| | decfsz | Deb_Counter,f | ; have we finished yet |
| | goto Bp1 | ; do next cycle | |
| | return | | |

END

APPENDIX 3
PC Windows Application Code

```
unit SerialNGBasicDemoMain;
interface
uses
  Windows, Messages, SysUtils, Classes, Graphics, Controls, Forms,
  Dialogs, StdCtrls, Buttons, ExtCtrls, SerialNG, ShellApi, DBCtrls,
  Mask, DB, ADODB, ComCtrls, ShellCtrls;
type
  TForm1 = class(TForm)
    BasicSettingsBtn: TButton;
    Terminal: TMemo;
SerialPortNG1: TSerialPortNG;
    ADOConnection1: TADOConnection;
    DataSource1: TDataSource;
    ADOTable1: TADOTable:
    DBNavigator1: TDBNavigator;
    DBEdit1: TDBEdit;
    Label1: TLabel;
    DBEdit2: TDBEdit;
    Label3: TLabel;
    OpenDialog1: TOpenDialog;
    Button1: TButton;
    procedure BasicSettingsBtnClick(Sender: TObject);
    procedure SerialPortNG1RxClusterEvent(Sender: TObject);
    procedure FormDestroy(Sender: TObject);
    procedure FormCreate(Sender: TObject);
    procedure Button1Click(Sender: TObject);
  private
    { Private declarations }
  public
    { Public declarations }
  end;
var
  Form1: TForm1;
implementation
uses SerialNGBasic;
{$R *.DFM}
procedure AddHexString(S : String; Lines : TStrings);
var AddS, HexS, CopyS : String;
    i : Integer;
const SLen = 8;
begin
  while Length(S) > 0 do
    begin
      AddS := Copy(S,1,SLen);
      HexS := ‘’;
      Delete(S,1,SLen);
      for i := 1 to SLen do
        begin
          CopyS := Copy(AddS,i,1);
          if CopyS <> ‘’ then
            HexS := HexS + ‘ ’ + Format(‘%2.2x’,[Byte(CopyS[1])]) //
          else
            HexS := HexS + ‘ ’;
        end;
      while Length(AddS) < SLen do
        AddS := AddS + ‘ ’;
      for i := 1 to SLen do
        case AddS[i] of
          #0..#31 : AddS[i] := ‘.’;
          #127 : AddS[i] := ‘.’;
        end;
      Lines.Add(HexS+’ : ‘+AddS);
    end;
end;
procedure TForm1.BasicSettingsBtnClick(Sender: TObject);
begin
  SerialNGBasicDLG.SetDLGData(SerialPortNG1);
  if SerialNGBasicDLG.ShowModal = mrOK then
    SerialNGBasicDLG.GetDLGData(SerialPortNG1);
end;
```

1. A method of making a book including interconnected electrical components, the
method comprising the step of applying a conductive ink to a sheet of material to define a conductive track on the sheet from a point on the surface of the sheet to the edge of the sheet such that the conductive track extends beyond the edge of the sheet generally in the plane of the sheet to form an electrical connection point.

2. A method as claimed in claim 1, wherein the conductive track extends beyond the edge of the sheet by virtue of the surface tension of the wet conductive ink.

3. A method as claimed in claim 1 further comprising the step of forming a stack comprising a plurality of said sheets.

4. A method as claimed in claim 3, wherein the electrical connection points of successive sheets in the stack are aligned in a direction perpendicular to the plane of the sheet, such that the electrical connection points form an electrical contact from sheet to sheet.

5. A method as claimed in claim 4, wherein the aligned electrical connection points provide a conductive pathway from a first sheet of the stack having a conductive track defined thereon to another sheet of the stack, preferably the lowest sheet of the stack.

6. A method as claimed in claim 3, wherein the stack includes sheets with electrical connection points having a conductive track of negligible length such that the electrical connection points operate only to connect electrically the neighbouring sheets in the stack.

7. A method as claimed in claim 1, wherein the conductive ink is applied to the sheet by printing, preferably screen printing.

8. A method as claimed in claim 3 further comprising the step of binding the stack of sheets into a book.

9. A book made according to a method as claimed in claim 1.

10. A method of making a book substantially as hereinbefore described.

11. A book substantially as hereinbefore described.
